(19) United States
(12) Patent Application Publication
(10) Pub. No.: US 2026/0082298 A1
(43) Pub. Date: Mar. 19, 2026

(54) METHODS AND SYSTEMS FOR MANAGING DATA TRAFFIC IN AN AERIAL COMMUNICATION NETWORK

(71) Applicant: SAMSUNG ELECTRONICS CO., LTD., Suwon-si (KR)

(72) Inventors: Tushar Vrind, Bengaluru (IN); Debabrata Das, Bengaluru (IN)

(73) Assignee: SAMSUNG ELECTRONICS CO., LTD., Suwon-si (KR)

(21) Appl. No.: 19/301,389

(22) Filed: Aug. 15, 2025

(30) Foreign Application Priority Data
Sep. 19, 2024 (IN) 202441070986
Aug. 5, 2025 (IN) 202441070986

(51) Int. Cl. H04W 36/22; H04W 36/32; H04W 36/36; H04W 84/06

(52) U.S. Cl. CPC H04W 36/22; H04W 36/322; H04W 36/362; H04W 84/06

(57) ABSTRACT

A method includes: predicting data traffic for user equipment (UEs) for an aerial scheduling period (ASP), wherein the UEs are connected to aerial base stations (UXNBs); creating a time-variant adjacency scheme for the UEs for the asp, wherein the time-variant adjacency scheme indicates an inter-UE communication weight between each pair of UEs; forming a plurality of group of UEs based on the time-variant adjacency scheme, wherein the inter-UE communication weight between each pair of UEs in the plurality of group of UEs exceeds a predefined threshold value; and allocating each group of UEs to an aerial base station (UXNB), based on at least one of the predicted data traffic, coverage information of each UE in a corresponding group of UEs, and a predefined capacity of the UXNB, wherein the coverage information of each UE matches with a coverage zone of the UXNB.

### CROSS-REFERENCE TO RELATED APPLICATIONS

This application is based on and claims priority under 35 U.S.C. § 119 to Indian Provisional Patent Application No. 202441070986, filed on Sep. 19, 2024, and Indian Patent Application No. 202441070986, filed on Aug. 5, 2025, in the Indian Patent Office, the disclosure of which is incorporated by reference herein in its entirety.

### BACKGROUND

The present disclosure relates to wireless communication, and more particularly, relates to aerial communication. Specifically, the present disclosure further relates to a system and a method for managing data traffic in an aerial communication network.

The telecommunications landscape is rapidly evolving, with Non-Terrestrial Networks (NTNs) emerging as a potential solution to augment terrestrial networks and expand telecommunication operator capacity and coverage. NTNs include a range of deployment strategies involving aerial cells at varying altitudes, i.e., low altitude (less than a kilometer), high altitude (several kilometers), and satellite orbits. These aerial deployments offer considerable advantages such as extended coverage and enhanced network capacity. For example, aerial cells are particularly useful for scenarios where temporary network scalability is required, such as during peak traffic hours, congestion events, or gatherings like sports events, music festivals, and conferences. In such scenarios, aerial cells may augment terrestrial cells in a Dual Connectivity (DC) mode. Recent studies have explored trajectory planning for aerial cells, both in augmented and standalone deployment configurations.

However, the deployment and operation of aerial cells present significant challenges, especially when compared to traditional terrestrial networks. For example, Low-Altitude Platform (LAP)-based aerial cells are particularly beneficial for enhancing coverage and capacity. However, LAP-based aerial cells come with unique operational complexities. One of the primary challenges is balancing Capital Expenditure (CAPEX) and Operational Expenditure (OPEX). On one hand, minimizing the fleet size is critical to reducing CAPEX. At the same time, it is essential to optimally associate one or more User Equipment (UEs) with aerial cells. The associations between the one or more UEs with the aerial cells ensure the maximization of aerial cell resources and allow providing services to a greater number of UEs. Further, although LAPs have a lower CAPEX in comparison to higher-altitude platforms, the efficient management and operation of a fleet of LAPs within a cellular network remain critical. LAPs are characterized by limited hovering durations and frequent replacement requirements. Therefore, it is essential to maximize resource utilization during deployment while minimizing the number of LAPs in operation.

Further, efficient trajectory planning is critical for LAP-based aerial cells to achieve optimal resource utilization and to ensure effective service delivery. Recent advances in artificial intelligence and machine learning have introduced techniques, such as Feed-Forward Neural Networks (FFNN) and Long Short-Term Memory Networks (LSTM), to optimize aerial cell positioning. Despite these innovations, challenges remain, particularly in UE association and load balancing within overlapping coverage areas. In aerial communication, overlapping coverage areas refer to regions where the coverage from multiple aerial cells or platforms intersect.

Further, in Dual Connectivity (DC) scenarios, LAPs typically serve as secondary cells (SCGs) to terrestrial cells acting as the primary or master cell group (MCG). However, when terrestrial cells are unavailable, LAPs operate in standalone mode, directly serving UE. Efficient user association and load balancing between terrestrial and aerial cells are critical to ensuring seamless network operation.

Further, both the terrestrial and the aerial cells have limited capacity, and user demands are dynamic. Accordingly, the network operators employ load-balancing techniques to distribute users efficiently across available cells. In the context of aerial cells, load balancing involves managing the trajectory of these cells to ensure the effective distribution of resources. However, aerial communication presents unique challenges compared to traditional terrestrial networks. One challenge is the limited hovering time of LAP-based aerial cells, which necessitates optimal resource utilization. Additionally, complex trajectory planning is required for the deployment of aerial cells. Another challenge is maximizing resource allocation within the constraints of limited hovering time. Aerial cell operations must also be managed across different carrier frequencies and overlapping coverage areas in augmented deployments. Furthermore, there are challenges in the UE association, particularly in areas where aerial cells on different carrier frequencies overlap.

Conventional techniques for load balancing in cellular networks, including those using Reinforcement Learning (RL) models like Multi-Armed Bandit (MAB) approaches, Markov Decision Processes (MDP), and Deep RL Algorithms, have been explored to manage user association and to optimize resource utilization. Techniques for load balancing in combined terrestrial and non-terrestrial networks have also been studied, with a focus on satellite-based NTNs and the use of Radio Resource Utilization Ratio (RRUR) metrics to manage load across overlapping cells. However, such approaches have not been fully adapted to address the unique challenges of LAP-based aerial cells, especially in standalone deployments.

Further, some conventional techniques often frame load balancing problems as Knapsack Optimization (KO) problems. In KO problems, network capacity is considered the size of the knapsack, while traffic flows are defined by weight (representing data volume) and profit (representing priority). Variations of KO, such as the Multiple Knapsack Problem (MKP), have been applied to manage data flows in cellular networks. Such techniques have shown promise in balancing user association in dense small-cell environments. Further, KO-based techniques also help manage load balancing between Macro Base Stations (MBS) and LAPs as data caches. However, KO-based techniques have not adequately addressed standalone LAP-based node deployments. The KO-based techniques also do not fully consider the interdependence of UEs within overlapping coverage areas.

With the advent of sixth-generation (6G) networks, the rapid increase in multimedia sharing and user-generated content has underscored the need for more efficient load balancing. Optimal load balancing ensures that inter-user data traffic is consolidated within the same cell, reducing latency and enhancing bandwidth utilization. This is crucial for maintaining a responsive network and providing seamless experiences for multimedia applications.

However, existing techniques for load balancing largely fail to consider the specifics of LAP-based aerial cell deployments, particularly the interdependence between UEs during user association in scenarios with multiple LAPs covering overlapping areas. The treatment of interdependent user data traffic while performing user association to LAP-based aerial cells remains largely unexplored, especially in cases where multiple LAPs operate on different carrier frequencies and have overlapping coverage areas. Additionally, the need for optimizing resource utilization in a way that minimizes CAPEX and OPEX continues to present a significant challenge for network operators.

Therefore, in view of the above-mentioned problems, it is advantageous to provide an improved system and method that overcome the above-mentioned problems and limitations associated with aerial communication networks.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to an aspect of the disclosure, a method for managing data traffic in an aerial communication network, includes: predicting the data traffic for each of a plurality of user equipment (UEs) for an aerial scheduling period (ASP), wherein the plurality of UEs are connected to a plurality of aerial base stations (UxNBs) in the aerial communication network; creating a time-variant adjacency scheme for the plurality of UEs for the ASP, wherein the time-variant adjacency scheme indicates an inter-UE communication weight between each pair of UEs among the plurality of UEs; forming a plurality of group of UEs based on the time-variant adjacency scheme for the ASP, wherein the inter-UE communication weight between each pair of UEs in the plurality of group of UEs exceeds a predefined threshold value; and allocating each group of UEs among the plurality of group of UEs to an aerial base station (UxNB) among the plurality of UxNBs, based on at least one of the predicted data traffic, coverage information of each UE in a corresponding group of UEs, and a predefined capacity of the UxNB, wherein the coverage information of each UE matches with a coverage zone of the UxNB.

According to an aspect of the disclosure, a system for managing data traffic in an aerial communication network, the system comprising at least one processor configured to: predict data traffic for each of a plurality of user equipment (UEs) for an aerial scheduling period (ASP), wherein the plurality of UEs are connected to a plurality of aerial base stations (UxNBs) in the aerial communication network; create a time-variant adjacency scheme for the plurality of UEs for the ASP, wherein the time-variant adjacency scheme indicates an inter-UE communication weight between each pair of UEs among the plurality of UEs; form a plurality of group of UEs based on the time-variant adjacency scheme for the ASP, wherein the inter-UE communication weight between each pair of UEs in the plurality of group of UEs exceeds a predefined threshold value; and allocate each group of UEs among the plurality of group of UEs to an aerial base station (UxNB) among the plurality of UxNBs, based on at least one of the predicted data traffic, a coverage information of each UE in a corresponding group of UEs, and a predefined capacity of the UxNB, wherein the coverage information of each UE matches with a coverage zone of the UxNB.

According to an aspect of the disclosure, a method for managing data traffic of a plurality of user equipment (UEs) in an aerial communication network, includes: predicting data traffics of the plurality UE during an aerial scheduling period (ASP), wherein the plurality of UEs are operatively connected to a plurality of aerial base stations (UxNBs) in the aerial communication network; calculating a time-variant adjacency scheme about the plurality of UEs for the ASP, wherein the time-variant adjacency scheme is a matrix including inter-UE communication weights among the plurality of UEs; forming a group of UEs based on the time-variant adjacency scheme for the ASP, wherein an inter-UE communication weight of the group of UEs exceeds a predefined threshold value; and allocating the group of UEs to an aerial base station (UxNB) among the plurality of UxNBs, based on at least one of the predicted data traffic, coverage information of each UE in the group of UEs, and a predefined capacity of the UxNB, wherein the coverage information of each UE matches with a coverage zone of the UxNB.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example of an aerial communication network that supports the management of data traffic, in accordance with an embodiment of the present disclosure;

FIG. 2 illustrates a block diagram of a system for managing data traffic in the aerial communication network, in accordance with an embodiment of the present disclosure;

FIG. 3 illustrates a flow chart depicting a method for managing data traffic in the aerial communication network, in accordance with an embodiment of the disclosure;

FIG. 4 illustrates a signal flow diagram depicting a handover process in the aerial communication network, in accordance with existing art; and

FIGS. 5A-5B illustrate signal flow diagrams depicting a handover process in the aerial communication network, in accordance with an embodiment of the disclosure.

Further, skilled artisans will appreciate that those elements in the drawings are illustrated for simplicity and may not have necessarily been drawn to scale. For example, the flow charts illustrate the method in terms of the most prominent operations involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

Those skilled in the art may understand that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . . ” or “one or more elements is required.”

Reference is made herein to some “embodiments.” An embodiment is an example of a possible implementation of any features and/or elements of the present disclosure. Some embodiments have been described for the purpose of explaining one or more of the potential ways in which the specific features and/or elements of the proposed disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore are not necessarily be taken as limiting factors to the proposed disclosure.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data may be permanently stored and media where data may be stored and later overwritten, such as a rewritable optical disc or an erasable memory device.

Embodiments of the present disclosure will be described below in detail with reference to the accompanying drawings.

In the present disclosure, the terms “aerial cell” and “aerial base station” have been used interchangeably throughout the description and drawings.

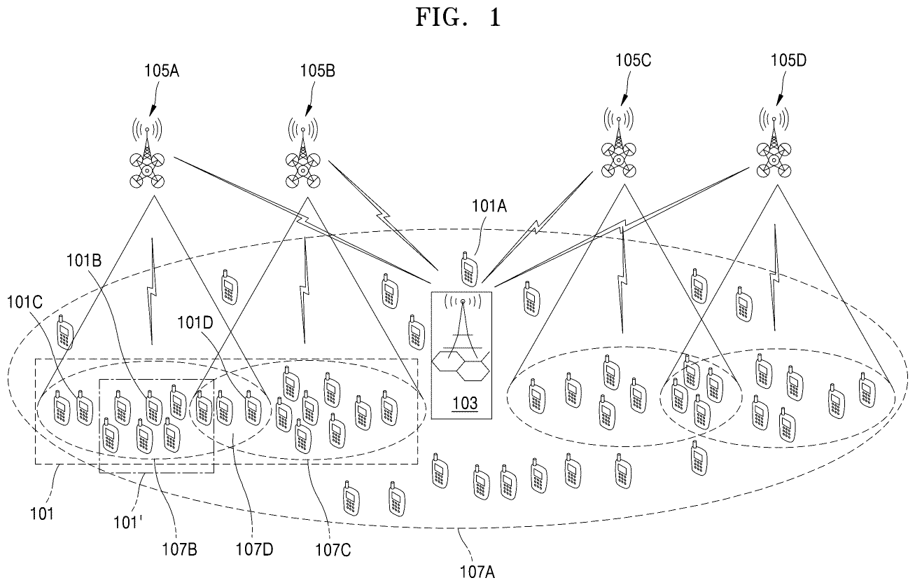

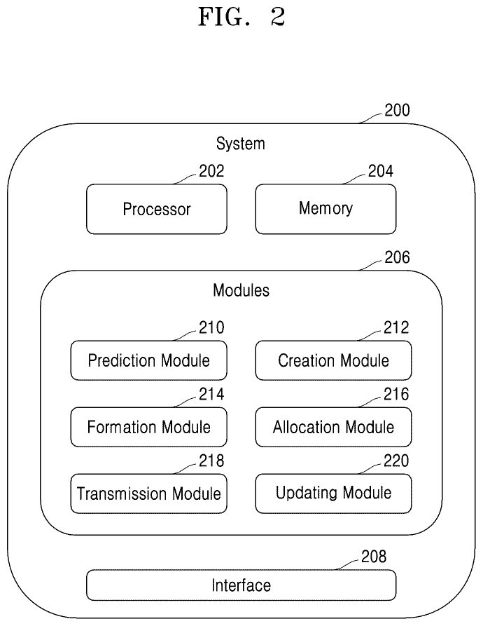

The first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2. Further, similar reference numerals have been used to represent similar components in the Figures.

In the present disclosure, terms, and names defined in wireless communication standards, which are the latest standards defined by the Third Generation Partnership Project (3GPP) organization among existing communication standards, are used. However, the present disclosure is not limited by the terms and names and may be equally applied to systems conforming to other standards. In addition, the embodiment of the present disclosure may be applied to other communication systems having a similar technical background. In addition, the embodiments of the present disclosure may be applied to other communication systems through some modifications within a range that does not significantly depart from the scope of the present disclosure as judged by a person having skilled technical knowledge.

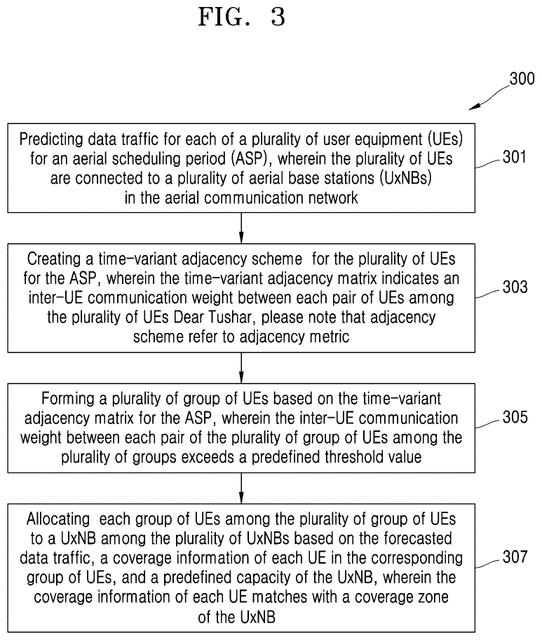

FIG. 1 illustrates an example of an aerial communication network (ACN) 100 that supports the management of data traffic, in accordance with an embodiment of the present disclosure. FIG. 2 illustrates a block diagram of a system 200 for managing data traffic in the aerial communication network 100, in accordance with an embodiment of the disclosure. FIG. 3 depicting a flow chart depicting a method 300 for managing data traffic in the aerial communication network 100, in accordance with an embodiment of the disclosure. For the sake of brevity, the description of FIGS. 1-3 are explained in conjunction with each other.

Referring to FIG. 1, as shown, the ACN 100 is a wireless communication system that integrates a terrestrial base station (BS) 103, a plurality of Aerial Base Stations (UxNBs) 105A, 105B, 105C, 105D (also referred hereinafter as a plurality of UxNBs 105), and a plurality of UEs 101 to enhance network coverage, capacity, and reliability of the network 100. The base station 103 described herein may include or may be referred to by a person having ordinary skill in the art as a base transceiver station, a radio base station, an access point, a radio transceiver, a NodeB, an eNodeB (eNB), a next-generation NodeB or a gNodeB (either of which may be referred to as a gNB), a Home NodeB, a Home eNodeB, or other suitable terminology.

The plurality of UEs 101 may include or may be referred to as a mobile device, a wireless device, a remote device, a handheld device, a subscriber device, or some other suitable terminology, where the “device” may also be referred to as a unit, a station, a terminal, or a client, among other examples. The plurality of UEs 101 may also include or may be referred to as a personal electronic device, such as a cellular phone, a personal digital assistant (PDA), a tablet computer, a laptop computer, or a personal computer. In some examples, the plurality of UEs 101 may include or be referred to as a Wireless Local Loop (WLL) station, an Internet of Things (IoT) device, an Internet of Everything (IoE) device, or a Machine-Type Communications (MTC) device, among other examples, which may be implemented in various objects such as appliances, or vehicles, meters, among other examples. Further, the plurality of UEs 101 may correspond to a UE with a single Subscriber Identity Module (SIM) or a UE with a multi-SIM.

The plurality of UEs 101 described in the present disclosure may be able to communicate with various types of devices, such as other UEs 101 that may sometimes act as relays as well as the base station 103 and the network equipment including macro eNBs or gNBs, small cell eNBs or gNBs, or relay base stations, among other examples, as shown in FIG. 1.

The ACN 100 leverages UxNBs, such as Unmanned Aerial Vehicles (UAVs), High-Altitude Platform Stations (HAPS), and drones, to extend the capabilities of traditional terrestrial networks, particularly in challenging environments like disaster-affected areas, remote locations, and high-density urban regions. The ACN 100 operates through a combination of terrestrial components, such as the BS 103, and aerial components, such as the plurality of UxNBs 105. In particular, the BS 103 serves as the central ground-based base station and provides backhaul connectivity to the plurality of UxNBs 105 while directly servicing nearby UEs 101. Each of the plurality of UxNBs 105 may act as ‘relay nodes’ between the BS 103 and the plurality of UEs 101, dynamically adjusting their positions to optimize coverage and signal strength. In an embodiment, each of the plurality of UxNBs 105 establishes wireless backhaul connections with the BS 103 and works collaboratively with the terrestrial infrastructure to offload traffic and enhance service quality. Further, each UxNB may include Single Input Single Output (SISO) and Multiple Input Multiple Output (MIMO) antenna setups to communicate with the plurality of UEs 101 and the BS 103.

Further, each of the plurality UEs 101 may connect to either the BS 103 or any of the plurality of UxNBs 105 based on signal availability and network conditions. The coverage zones depicted in FIG. 1 illustrates how BS 103 and the plurality of UxNBs 105 create overlapping communication areas, allowing for adaptive handovers that ensure seamless connectivity. As shown, the BS 103 may provide a coverage area 107A over which the plurality of UEs 101 and the BS 103 may establish communication links. The coverage area 107A may be an example of a geographic area over which the BS 103 and one of the plurality of UEs 101 may support the communication of signals according to one or more radio access technologies. The UxNB 105A provides a coverage area 107B and the UxNB 105B provides a coverage area 107C. Further, multiple UxNBs 105 may operate on different carrier frequencies and cover an overlapping geographical area 107D, in contrast to terrestrial cells, i.e., BS 103 that are fixed and non-overlapping during infrastructure deployment, as shown in FIG. 1.

Accordingly, a UE, such as UE 101D may be in a location that has coverage from more than one UxNB, such as UxNB 105A and UxNB 105B. As the frequency carriers are independent for each UxNB, the overlapping coverage zone 107D does not create any additional interference in uplink or downlink. Accordingly, the UE 101D may switch the frequency carrier when the UE 101D changes its association from one UxNB to the other. Further, interference in the overlapping geographical area 107D may be avoided by having different carrier frequency assigned to each of the plurality of UxNBs 105. The UEs belonging to the overlapping geographical area 107D may get services from any one of the plurality of UxNBs 105, by appropriately selecting one of the UxNBs 105. Each UxNB is connected to an operator network via the BS 103 (also referred to as a terrestrial cell). However, some UEs, such as UE 101A in the network are not within the coverage area of any of the UxNBs 105. Accordingly, such UEs solely receive services from the BS 103.

Further, in an embodiment, the positioning of each of the plurality of UxNBs 105 within the ACN 100 is determined by an extensive capacity analysis for both SISO and MIMO antenna setups in the corresponding UxNB. An aggregate ‘path loss’ (PL) for each of the plurality of UxNBs 105 with all environmental considerations is given by equation (1):

$$P L = P {L}_{los} \times p ( los ) + P {L}_{nlos} \times p ( nlos ) \qquad ( 1 )$$

where p(los) is the probability of having a ‘Line of Site’ (LOS) link between a UE among the plurality of UEs 101, such as UE 101B, and the UxNB 105A, and p(nlos) is the probability of having a Non-Line of Site (NLOS) link between the UE 101B and the UxNB 105A, and intuitively p(nlos)=1−p(los).

A thorough altitude-aware capacity analysis yields the appropriate positioning of the plurality of UxNBs 105 based on area spectral efficiency (ASE). In this context, an optimization function determines an optimal height (h*) that maximizes the coverage area radius (r) of the coverage area, such as coverage area 107B while ensuring that the average ASE exceeds a specified threshold (Cap_{Thresh}) is given by equation (2):

$${h}^{*} = arg {max}_{Cap ( h , R ) > {Cap}_{Thresh}} ( r ) \qquad ( 2 )$$

The present disclosure discloses techniques to distribute users and the coverage areas of the plurality of UxNBs 105 while maintaining the load balancing between the gNB 103 and the plurality of UxNBs 105.

Further, the plurality of UEs 101 may select a Low-Altitude Platform (LAP) UxNB based on a plurality of aerial cell selection criteria, such as reference power and quality indicators associated with one or more of the plurality of UxNBs 105. Further, one UxNB, such as the UxNB 105A, may serve a limited number of UEs, and the association of UE with the UxNB 105A is dependent on both the coverage as well as the available capacity with the UxNB 105A. For example, there are (set of) N UxNBs given by (UxNB₁, UxNB₂, . . . , UxNB_{N}) and K UEs given by (UE₁, UE₂, . . . , UE_{N}) in the ACN 100. Further, ki users are associated with a UxNBᵢ in the ASP (τ_{ALB}). The set of UEs associated with UxNB with index i is defined in equation (3) (shown below) and the condition that a UE is associated with only one UxNB in a given scheduling period is defined in equation (4):

$${U}^{{UxNB}_{i}} ( t ) = \{ {UE}_{{k}_{1}} , … {UE}_{{k}_{i}} \} , {\sum }_{i = 0}^{i = N} {k}_{i} \geq K \qquad ( 3 )$$

$${U}^{{UxNB}_{i} ( t )} ⋂ {U}^{{UxNB}_{j}} ( t ) = ∅ , ∀ i \neq j \qquad ( 4 )$$

Further, a blocking ratio in every scheduling period is given by equation (5) (shown below). The blocking ratio may be defined as the proportion of unserved UEs to all UEs, i.e., the plurality of UEs 101 in the ACN 100.

$$B R ( t ) = 1 - \frac{( {\sum }_{i = 0}^{i = N} {k}_{i} )}{K} \qquad ( 5 )$$

The total capacity of an UxNB with index i is given by

$$U x N {B}_{i}^{c a p} .$$

The available (or remaining) capacity of the UxNB in the scheduling period (τ_{ALB}) after all the UEs, i.e., the plurality of UEs 101 are associated with the UxNB is given by

$$U x N {B}_{i}^{a v l} ( i ) .$$

Accordingly, the present disclosure provides techniques for load balancing in an aerial communication network. In an embodiment, the UEs are associated with Low-Altitude Platform (LAP) aerial base stations (UxNB) where the UxNBs have overlapping coverage zones. Further, the present disclosure provides techniques to change the UE association dynamically based on factors of capacity as well as coverage. Further, the disclosed techniques maximize the served UEs and minimize the blocking ratio by dynamically changing the association of UEs to UxNB.

Referring to FIG. 2, the system 200 may include at least one processor 202 (“a processor”), a memory 204, modules 206, and an interface 208. The memory 204, the modules 206, and the interface 208 may be coupled to the processor 202. In an embodiment, the system 200 may be a part of at least one of the plurality of UxNBs 105. In another embodiment, the system 200 may be coupled to any of at least one of the plurality of UxNBs 105. In such an embodiment, the system 200 may be located on a device coupled to at least one of the plurality of UxNBs 105.

The processor 202 may be a single processing unit or several units, all of which could include multiple computing units. The processor 202 may be implemented as one or more microprocessors, microcomputers, microcontrollers, digital signal processors, central processing units, state machines, logic circuitries, and/or any device that manipulates signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. Further, the memory 204 may include an operating system for performing one or more tasks of the system 200, as performed by a generic operating system in the communications domain.

The modules 206 may include routines, programs, objects, components, data structures, etc., which perform particular tasks or implement data types. The modules 206 may also be implemented as, signal processor(s), state machine(s), logic circuitries, and/or any other device or component that manipulates signals based on operational instructions.

Further, the modules 206 may be implemented in hardware, instructions executed by a processing unit, computer code(s), or by a combination thereof. The processing unit may include a computer, a processor, such as the processor 202, a state machine, a logic array, or any other suitable wearable device capable of processing instructions. The processing unit may be a general-purpose processor which executes instructions to cause the general-purpose processor to perform the required tasks or, the processing unit may be dedicated to performing the required functions. In another embodiment of the present disclosure, the modules 206 may be machine-readable instructions (software) which, when executed by a processor/processing unit, perform any of the functionalities described herein.

In some embodiments, the modules 206 may include a set of instructions that may be executed to cause the system 200 to perform any one or more of the methods disclosed herein. The modules 206 may be configured to perform the operations of the present disclosure using the data stored in the memory 204 to facilitate managing data traffic in the A 100, as discussed throughout this disclosure. In an embodiment, each of the modules 206 may be hardware units that may be outside the memory 204.

In an embodiment, the modules 206 may include a prediction module 210, a creation module 212, a formation module 214, an allocation module 216, a transmission module 218, and an updating module 220. The modules 206 and their working is further explained in detail in the following paragraphs.

The various modules 210-220 (the prediction module 210, the creation module 212, the formation module 214, the allocation module 216, the transmission module 218, and the updating module 220) may be in communication with each other. In an embodiment, the various modules 210-220 may be a part of the processor 202. In another embodiment, the processor 202 may be configured to perform the functions of modules 210-220.

Referring now to FIG. 3, at operation 301, the method 300 may include predicting data traffic for each of the plurality of UEs 101 for an aerial scheduling period (ASP) (τ_{ALB}). The ASP may refer to a period during which the plurality of UxNBs 105 are within the coverage area 107A of the gNB 103. Further, as shown in FIG. 1, the plurality of UEs 101 are connected to the plurality of aerial base stations (UxNBs) 105 in the ACN 100. In an embodiment, the prediction module 210 may predict the data traffic for each of the plurality of UEs 101 based on at least one of the historical data of the corresponding UE, real-time network conditions associated with the aerial communication network 100 and predicted communication requirements (also referred to as “inter-UE data exchanges”) for the corresponding UE.

In an embodiment, the inter-UE data exchanges refer to data communication between two UEs, such as UE 101B and UE 101C. The inter-UE data exchanges play a crucial role in situations where the plurality of UEs 101 interact heavily with each other, as the inter-UE data exchanges may greatly impact the experience of the UEs. In particular, there are several example use cases where inter-UE data exchanges are essential. In real-time gaming, for instance, low latency is vital for ensuring smooth gameplay and a responsive experience for players in multiplayer scenarios.

Similarly, in vehicular networks, the vehicles need to exchange critical information, such as traffic updates, with minimal delay to improve safety and network efficiency. Industrial automation also relies on real-time communication between machines to coordinate actions, especially in fast-paced environments like manufacturing or assembly lines, where quick response times are essential.

Further, edge computing scenarios, which involve processing data near its source, benefit from this classification by reducing latency and boosting performance. The inter-UE data exchanges are particularly important in scenarios where UEs have high levels of interaction with each other, as the inter-UE data exchanges may significantly affect the experience of the communicating devices. In such scenarios, inter-UE data exchanges for communication between UEs may be routed via the UxNBs, bypassing the gNB 103 if the two UEs are associated with the UxNB. This approach reduces the time taken for data to travel between UEs, leading to increased responsiveness, lower latency, and lower energy requirements for data communication. Accordingly, the prediction module 210 may predict the data traffic for the ASP based on the historical data and the inter-UE data exchanges.

In an embodiment, the prediction module 210 may include a pre-trained Deep Neural Network (DNN) model to predict the data traffic for each of the plurality of UEs 101. The pre-trained DNN model may be expressed as h_{DNN}(t), where h_{DNN}(t) is an inference from the pre-trained DNN model, for the ASP (τ_{ALB}). Accordingly, a predicted traffic buffer for UE index i is given by equation (6):

$${UE}_{i}^{traffic} ( t ) = {h}_{DNN} ( previous t traffic features ) \qquad ( 6 )$$

where, the previous t traffic features may include historical data of the corresponding UE, real-time network conditions associated with the aerial communication network 100, and the inter-UE data exchanges for the corresponding UE.

Referring again to FIG. 3, at operation 303, the method 300 may include creating a time-variant adjacency scheme for the plurality of UEs for the ASP (τ_{ALB}). The time-variant adjacency scheme (InterUE(t)) indicates an inter-UE communication weight between each pair of UEs among the plurality of UEs 101. For example, the time-variant adjacency scheme (InterUE(t)) may indicate an inter-UE communication weight between UE 101B and UE 101C. In an embodiment, the inter-UE communication weight indicates a strength of communication (i.e., inter-UE data exchange) between the corresponding pair of UEs, i.e., the UE 101B and the UE 101C. Accordingly, the creation module 212 may assign a weight to the strength of communication (i.e., inter-UE data exchange) between the corresponding pair of UEs and then create the time-variant adjacency scheme (InterUE(t)) based on the assigned weights.

In an example embodiment, the inter-UE communication weight may be assigned between a value of 0 and 1. For example, a weight of 0 value may indicate no inter-UE communication between the corresponding pair of UEs, i.e., the UE 101B and the UE 101C. Similarly, a weight of 1 value may indicate a tighter coupling, i.e., higher inter-UE communication between the corresponding pair of UEs, i.e. the UE 101B and the UE 101C. In particular, the inter-UE data exchange is available as a weighted time-variant adjacency scheme (InterUE(t)) given by equation (7):

$$InterUE ( t ) = [ \begin{matrix}0 & … & {C}_{1 K} \\ ⋮ & ⋱ & ⋮ \\ {C}_{K 1} & … & 0\end{matrix} ] \qquad ( 7 )$$

where Cᵢⱼ defines the inter-UE communication weight (after min-max normalization) between UE with index i and j. A value of ‘0’ means no inter-UE communication, and higher values (closer to 1) indicate a tighter coupling between the two UEs, i.e., the UE 101B and the UE 101C. All the diagonals are marked as ‘0’ indicating intra-UE communication between the two UEs. In addition, the time-variant adjacency scheme (InterUE(t)) is a symmetric scheme such that Cᵢⱼ=Cⱼᵢ for all i and j. Accordingly, in an embodiment, the time-variant adjacency scheme (InterUE(t)) is symmetric and includes zero diagonal values.

As a corollary to equation (7), the creation module 212 may create a single dimension time-variant scheme,

$$U {E}_{j}^{status} ( t )$$

for the corresponding UE, as shown in equation (8):

$$U {E}_{j}^{status} ( t ) = [ s {t}_{1} , {st}_{2} , … , {st}_{N} ] \qquad ( 8 )$$

where stᵢ indicates the state if the UEⱼ is in the coverage zone of the UxNB with index i. If stᵢ is ‘1’, UEⱼ is in the coverage zone of UxNBᵢ. However, if stᵢ is ‘0’, then the UEⱼ is not in the coverage zone of UxNBᵢ.

Thereafter, at operation 305, the method 300 may include forming a plurality of group of UEs based on the time-variant adjacency scheme (InterUE(t)) for the ASP (τ_{ALB}). The “plurality of group of UEs” may be or correspond to a plurality of groups each including UEs from the plurality of UEs.

For example, the formation module 214 may create a plurality of group of UEs. In an embodiment, the inter-UE communication weight between each pair of UEs in the plurality of group of UEs exceeds a predefined threshold value (Th_{c}). The predefined threshold value may be pre-configured or user-defined. In particular, the pair of UEs are together put in the same group which has higher weights above Th_{c} in the time-variant adjacency scheme (InterUE(t)), and have at least one common inter-UE communication path. For example, UE₁, UE₂, UE₅ belong to same group if C₁₂ satisfies the condition for the weight above Th_{c}, and either C₁₅, or C₂₅ satisfy the condition for the weight above Th_{c}.

Thereafter, at operation 307, the method 300 may include allocating each group of UEs among the plurality of group of UEs to a UxNB among the plurality of UxNBs. In an embodiment, the allocation module 216 may allocate each group of UEs, such as a group of UEs 101′ to the UxNB (such as UxNB 105A) based on the predicted data traffic, coverage information of each UE in the corresponding group of UEs, and a predefined capacity of the UxNB. For example, the allocation module 216 may allocate each group of the UEs, such as the group of UEs 101′ based on the predefined capacity of the UxNB 105A. The predefined capacity may refer to a capacity reserved with the UxNB 105A for allocation of the UEs. Hence, the UxNB 105A may be allocated to a limited number of UEs based on the predefined capacity. The coverage information of each UE matches with a coverage zone, such as 107B of the UxNB 105A. Further, the allocation module 216 may allocate each group of the UEs, such as the group of UEs 101′ based on the predicted data traffic. For example, when the predicted data traffic for UE1 is X1, for UE2 is X2, for UE3 is X3, and so forth. Further, the predefined capacity for the UxNB 105A is N1. The allocation module 216 allocates UE1 and UE3 to the UxNB 105A. The total capacity available with the UxNB 105A after allocation is N1−(X1+X3). Accordingly, the UE2 may be allocated to the UxNB 105A only when the predicted data traffic for the UE2 is less than N1−(X1+X3), i.e., X2<N1−(X1+X3).

In an embodiment, the coverage zone of the UxNB 105A is available in a set Z as zone Z_{UxNBi} for every ASP (τ_{ALB}) given by equation (9):

$$Z = \{ {Z}_{U x N {B}_{1}} , {Z}_{U x N {B}_{2}} , … {Z}_{U x N {B}_{N}} \} \qquad ( 9 )$$

Further, the coverage information of the UEs may be defined by equation (10):

$$U {E}^{{Z}_{U x N {B}_{i}}} ( t ) = \{ {UE}_{{z}_{1}} , … {UE}_{{z}_{i}} \} \qquad ( 10 )$$

where UE_{z1} . . . . UE_{zi} refers to the coverage information of the corresponding UE.

Further, once the plurality of groups of UEs is created, the allocation module 216 may use a Fractional Group Multiple Knapsack Problem (F-GMKP) approach to allocate a group of UEs 101′ to the UxNB 105A. The GMKP approach, a variant of a classical multiple knapsack issue, requires that items be divided into groups and that each group be packed in a different knapsack, also referred to as UxNBs. Further, the goal of GMKP is to maximize the overall value of the selected items given that the total weight of items in each knapsack does not exceed its capacity. Accordingly, in an embodiment, the allocation module 216 may divide the plurality of group of UEs 101′ into smaller sub-groups and place them into multiple knapsacks. Then, the allocation module 216 may allocate each group of the UEs, such as the group of UEs 101′ based on the predefined capacity of the UxNB 105A. Further, subject to the capacity restrictions of each UxNB, the objective is still to maximize the combined value of the items put inside the knapsacks.

Accordingly, the allocation module 216 may consider M disjoint sets (groups) of items, i.e., group of UEs, for every ASP (τ_{ALB}), as defined below in equation (11):

$$U {E}_{i}^{g r p} ( t ) = \{ U {E}_{j}^{i} \vert 1 \leq j \leq {n}_{i} \} \qquad ( 11 )$$

where

$${UE}_{j}^{i}$$

is the j^{th} UE of the i^{th} group. There are nᵢ UEs in each group. Each UE has the communication weight

$$w ( U {E}_{j}^{i} ) = {w}_{j}^{i} = U {E}_{j}^{{traffic}_{i}} ( t ) ,$$

from equation (6). There are N non-identical knapsacks (UxNBs), each having the predefined capacity of

$$U x N {B}_{i}^{c a p} .$$

There is a profit pᵢ for each set

$$U {E}_{i}^{g r p} ( t ) ,$$

which is given by equation (12) (shown below), the sum of all inter-UE weights of UEs in the group.

$${p}_{i} = {\sum }_{j = 1}^{j = {n}_{i}} {\sum }_{k = 1}^{k = {n}_{i}} InterUE ( t ) [ j ] [ k ] \qquad ( 12 )$$

In a further embodiment, the UEs may be allocated to the UxNB such that the total profit is maximized. However, not all UxNBs are available for all the UEs. Accordingly, there is an additional relationship given by equation (8), using which for each group

$$U {E}_{i}^{g r p} ( t ) ,$$

the coverage relationship status is given by equation (13):

$$U {E}_{i}^{{grp}_{status}} ( t ) = [ {\prod }_{j = 1}^{j = {n}_{i}} U {E}_{j}^{status} ( t ) [ 1 ] , … , {\prod }_{j = I}^{j = {n}_{i}} U {E}_{j}^{status} ( t ) [ N ] ] \qquad ( 13 )$$

Based on the

$$U {E}_{i}^{g r {p}_{s t a t u s}} ( t ) ,$$

the coverage status from some of the UxNB could likely be ‘0’, as all the UEs in the group may not be in the coverage zone for the same UxNB 105A. Further, the coverage relationship between the UxNB 105A and the group of UEs 101′ is maintained as given in equation (14) (shown below), which maintains the status of coverage from UxNBᵢ for each UE in the group,

$$U {E}_{i}^{g r p} ( t )$$

along the row i.

$${UE}_{i}^{{grp}_{coverage}} ( t ) = [ \begin{matrix}{UE}_{0}^{status} ( t ) [ 1 ] , … , {UE}_{{n}_{i}}^{status} ( t ) [ 1 ] \\ {UE}_{0}^{status} ( t ) [ 2 ] , … , {UE}_{{n}_{i}}^{status} ( t ) [ 2 ] \\ … \\ {UE}_{0}^{status} ( t ) [ N ] , … , {UE}_{{n}_{i}}^{status} ( t ) [ N ]\end{matrix} ] \qquad ( 14 )$$

Accordingly, there are different UxNBs available based on the coverage criteria of the UEs. Thus, the allocation module 216 may allocate a number of UEs in the group of UEs

$$( U {E}_{i}^{g r p} ( t ) )$$

to the UxNB 105A based on the coverage constraint given in equation (14). Accordingly, the number of UEs allocated to the UxNB 105A is within the coverage zone of the UxNB 1-5A. Further, the allocation module 216 may also perform the allocation based on fractional profit

$${p}_{i}^{f}$$

given by equation (15):

$${p}_{i}^{f} = {\sum }_{j = 1}^{j = {n}_{i}^{f}} {\sum }_{k = 1}^{k = {n}_{i}^{f}} InterUE ( t ) [ j ] [ k ] \qquad ( 15 )$$

where there are

$${n}_{i}^{f} UEs ( {n}_{i}^{f} \leq {n}_{i} )$$

allocated to the same knapsack (UxNB).

In an embodiment, the allocation module 216 may maintain a copy of InterUE(t) as InterUE_{FGMKP}(t) and may set Cᵢⱼ to ‘0’ as soon as the UEs from the group,

$$UEs ( {n}_{i} - {n}_{i}^{f} )$$

are allocated to the same UxNB 105A. The remaining

$$U {E}_{i}^{g r p} ( t )$$

are treated as a new group in the F-GKMP. The disclosed method may be applied to all M disjoint groups of UEs in the CAN 100. Additionally, the disclosed techniques may help in reducing the number of UxNBs in the deployment for each ASP (τ_{ALB}), while allowing the UxNBs to exchange the coverage zones. Thus, the disclosed techniques may utilize only a number of UxNBs (N_{ALB}) from the available N UxNBs, where N_{ALB}≤N. Accordingly, a total number of UxNBs used for allocation in the ASP may be less than or equal to a total number of available UxNBs.

For example, as shown in FIG. 1, four UxNBs are available in the ACN 100. Accordingly, the allocation module 216 may allocate the plurality of group of UEs to 4 or less than 4 UxNBs.

In a further embodiment, the allocation module 216 may further be configured to dynamically adjust the allocation of each group of the UEs to the UxNB 105A based on at least one of the mobility of the corresponding UE, the predicted data traffic of the corresponding UE, and network conditions associated with the aerial communication network 100. For example, if the UE 101D from the group of UEs 101′ moves away from the coverage zone 107D and moves towards the coverage zone 107E associated with the UxNB 105C, the allocation module 216 may allocate the UE 101D to the UxNB 105C.

In a further embodiment, a UxNB, such as the UxNB 105A may change its position every ASP (τ_{ALB}) based on a predefined trajectory plan associated with the UxNB 105A. Accordingly, the updating module 220 may update the coverage zone 107B of the UxNB 105A at the beginning (starting time point) of the ASP (τ_{ALB}) based on the predefined trajectory plan for the UxNB 105A. Accordingly, the allocation module 216 may update the allocation of each group of UEs to the UxNB based on the updated coverage zone of the UxNB 105A.

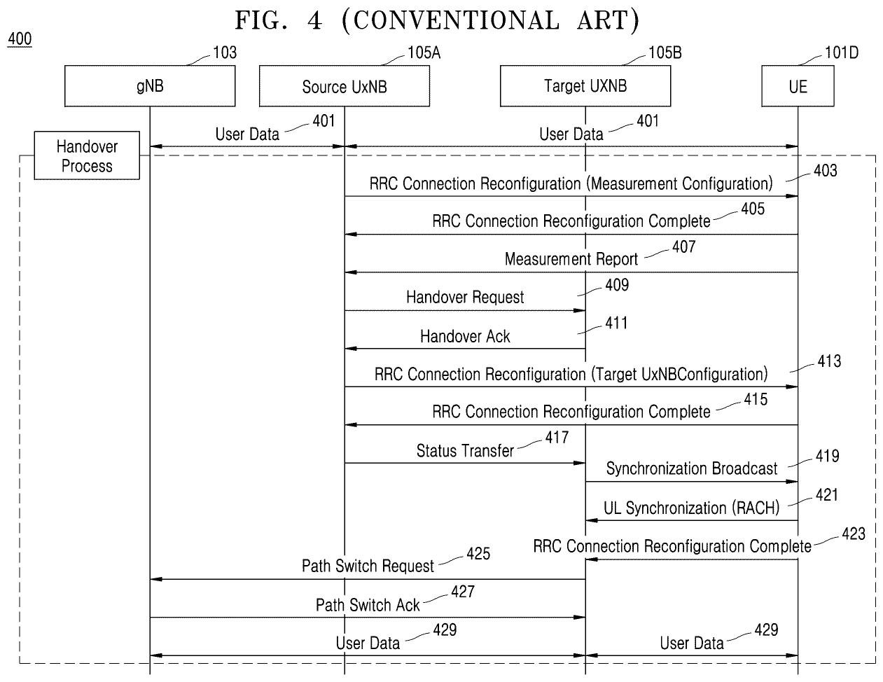

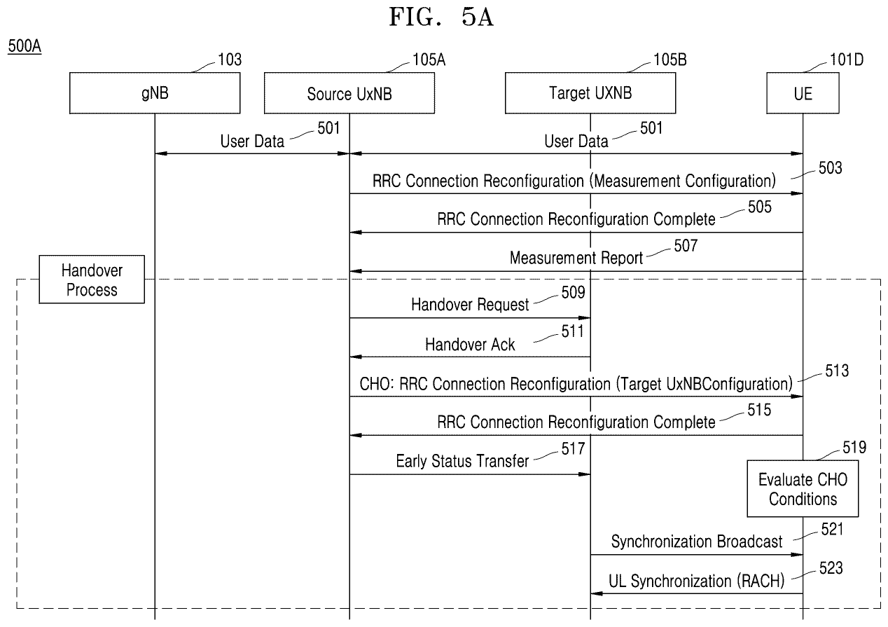

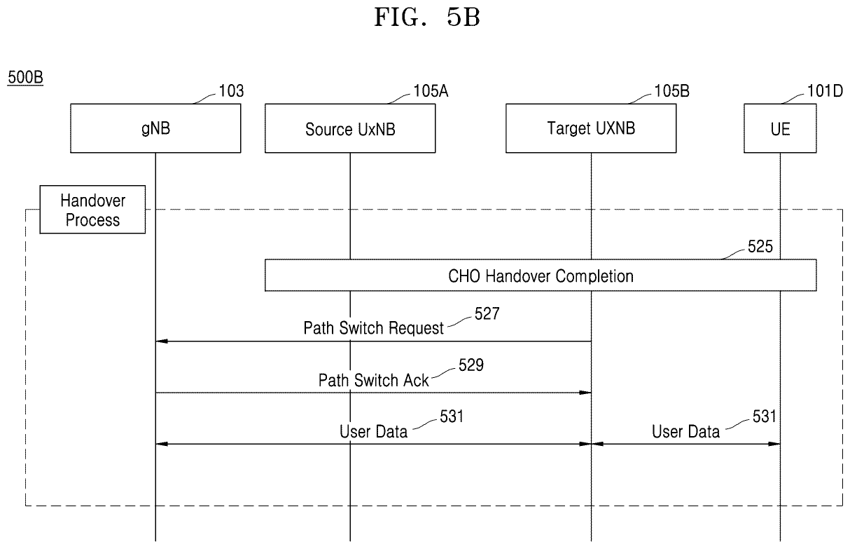

In a further embodiment, after allocation of the group of UEs 101′ to the UxNB 105A, the transmission module 218 may transmit a Conditional Handover (CHO) command to at least one UE among the plurality of UEs 101. The transmission module 218 may transmit the CHO command in every ASP τ_{ALB}. In an embodiment, the CHO command may include a list of UxNBs wherein one or more UxNBs in the list of UxNBs are selected based on the allocation of each group of the UEs to the UxNB 105A. The UE may perform the CHO to one of the one or more UxNBs based on signal power measurements. FIGS. 5A-5B illustrate the CHO process. In an embodiment, the disclosed CHO process is closely aligned with the HO procedure described in the related art (as illustrated in FIG. 4), with a variation that the UE may choose to handover to one of the one or more UxNBs.

FIG. 4 illustrates a handover process 400 in the aerial communication network 100, in accordance with related art. Even though FIG. 1 is a part of the present disclosure, FIG. 1 is used to explain FIG. 4 for ease of explanation and relatability. As shown in FIG. 4, at operation 401, a source UxNB 105A receives user data associated with UE 101D from the gNB 103 and the UE 101D. At operation 403, the source UxNB 105A transmits an RRC Connection Reconfiguration (Measurement Configuration) to the UE 101. At operation 405, the source UxNB 105A receives an RRC Connection Reconfiguration Complete message. At operation 407, the source UxNB 105A receives a measurement report from the UE 101D. Then, the source UxNB 105A chooses a target UxNB 105B for the UE after evaluating the received measurement report. Accordingly, at operation 409, the source UxNB 105A transmits a handover request to the target UxNB 105B. At operation 411, the source UxNB 105A receives a handover acknowledgment (ack) from the target UxNB 105B. At operation 413, the source UxNB 105A transmits an RRC Connection Reconfiguration message including the target UxNB configuration. At operation 415, the source UxNB 105A receives an RRC Connection Reconfiguration Complete message from the UE 101D. Then, at operation 417, the source UxNB 105A transfers the status of the UE 101D to the target UxNB 105B. At operation 419, the target UxNB 105B broadcasts synchronization information to the UE 101D. In response, at operation 421, the UE 101D transmits Uplink (UL) synchronization information to the target UxNB 105B. The synchronization information may be sent in a Random Access Channel (RACH). At operation 423, the UE 101D transmits an RRC Connection Reconfiguration Complete message to the target UxNB 105B. In response, at operation 425, the target UxNB 105B transmits a path switch request to the gNB 103. At operation 427, the target UxNB 105B receives a path switch acknowledgment (ack) from the gNB 103. Thereafter, at operation 429, user data is transmitted to the target UxNB 105B from the gNB 103 and the UE 101D.

FIGS. 5A-5B illustrate signal flow diagrams 500A, 500B depicting the handover process in the aerial communication network 100, in accordance with an embodiment of the present disclosure. As shown, at operation 501, a source UxNB 105A receives user data associated with UE 101D from the gNB 103 and the UE 101D. At operation 503, the source UxNB 105A transmits an RRC Connection Reconfiguration (Measurement Configuration) to the UE 101. At operation 505, the source UxNB 105A receives an RRC Connection Reconfiguration Complete message. At operation 507, the source UxNB 105A receives a measurement report from the UE 101D. Then, the source UxNB 105A chooses a target UxNB 105B for the UE after evaluating the received measurement report. Accordingly, at operation 509, the source UxNB 105A transmits a handover request to the target UxNB 105B. At operation 511, the source UxNB 105A receives a handover acknowledgment (ack) from the target UxNB 105B. At operation 513, the source UxNB 105A transmits an RRC Connection Reconfiguration message including the target UxNB configuration. In an embodiment, the target UxNB configuration may be associated with a UxNB allocated to the UE 101D in accordance with the techniques as described in reference to FIGS. 2-3. Accordingly, in an example embodiment, the target UxNB may be the UxNB 105B. At operation 515, the source UxNB 105A receives an RRC Connection Reconfiguration Complete message from the UE 101D. Then, at operation 517, the source UxNB 105A transfers the status of the UE 101D to the target UxNB 105B. At operation 519, the UE 101D evaluates CHO conditions associated with the CHO command. In an example embodiment, the CHO conditions may include instantaneous measurement results associated with the UE, preferences a target cell based on frequency of the target cell, and past experience on the cell. At operation 521, the target UxNB 105B broadcasts synchronization information to the UE 101D. In response, at operation 523, the UE 101D transmits Uplink (UL) synchronization information to the target UxNB 105B. The synchronization information may be sent in a Random Access Channel (RACH). At operation 525, the UE 101D transmits a CHO Handover Completion message to the target UxNB 105B. In response, at operation 527, the target UxNB 105B transmits a path switch request to the gNB 103. At operation 529, the target UxNB 105B receives a path switch acknowledgment (ack) from the gNB 103. Thereafter, at operation 531, user data is transmitted to the target UxNB 105B from the gNB 103 and the UE 101D.

In a further embodiment, the disclosed techniques may result in a reduced blocking ratio, as shown in equation (16) (shown below). The disclosed techniques may also result in reduced unutilized capacity from all UxNBs, given by the efficiency defined in equation (17) (shown below). The disclosed techniques may also result in reduced inter-UE latency, as shown in equation (18) (shown below). Accordingly, the sum of inter-UE communication weights for the UE which were in the same group of UEs (one of the M disjoint groups) initially, but are not associated with the same UxNB may be reduced, as given by equation (17).

$${BR}_{ALB} ( t ) = 1 - \frac{( {\sum }_{i = 0}^{i = {N}_{ALB}} {k}_{i} )}{K} \qquad ( 16 )$$

$${Eff}_{ALB} ( t ) = 1 - \frac{( {\sum }_{i = 1}^{i = {N}_{ALB}} {UxNB}_{i}^{avl} ( t ) ) )}{{\sum }_{i = 1}^{i = {N}_{ALB}} {UxNB}_{i}^{cap} ( t ) )} \qquad ( 17 )$$

$${InterUE}_{ALB} ( t ) = {\sum }_{i = 1}^{i = K} {\sum }_{j = 1}^{j = K} {InterUE}_{FGMKP} ( t ) [ i ] [ j ] \qquad ( 18 )$$

In a further embodiment, an objective function for F-GMKP used in the disclosed techniques is given as equation (19) (shown below) for ASP (τ_{ALB}), where (w₁+w₂+w₃=1), and the objective function has been applied as w₁=w₂=w₃=⅓.

$$min {w}_{1} \times B {R}_{A L B} ( t ) + {w}_{2} \times E f {f}_{A L B} ( t ) + {w}_{3} \times InterU {E}_{A L B} ( t ) \qquad ( 19 )$$

Further, in comparison to Multi-Dimensional Knapsack Problem (MKP) techniques, the disclosed techniques help in the reduction in inter-UE latency, as shown in equation (20) (shown below). The disclosed techniques also result in an improved blocking ratio, as shown in equation (21) (shown below). The disclosed techniques also result in improvement in UxNB utilization, as shown in equation (22):

$${InterUE}_{LatRed} = ( 1 - \frac{{\sum }_{i = 1}^{i = K} {\sum }_{j = 1}^{j = K} {InterUE}_{F G M K P} ( t ) [ i ] [ j ]}{{\sum }_{i = 1}^{i = K} {\sum }_{j = 1}^{j = K} InterU {E}_{M K P} ( t ) [ i ] [ j ]} ) \times 100 \qquad ( 20 )$$

$$B {R}_{g a i n} = ( \frac{{\sum }_{t = {τ}_{ALB // {τ}_{A L B}}}^{t = T / {τ}_{A L B}} ( {\sum }_{i = 0}^{i = N} {k}_{i}^{A L B} - {\sum }_{i = 0}^{i = N} {k}_{i}^{M K P} )}{( \frac{T}{{τ}_{A L B}} ) \times K} ) \times 100 \qquad ( 21 )$$

$$Ef {f}_{g a i n} = ( 1 - \frac{{\sum }_{i = 1}^{i {N}_{A L B}} U x N {B}_{i}^{a v l} ( t ) )}{{\sum }_{i = 1}^{i = {N}_{M K P}} U x N {B}_{i}^{a v l} ( t ) )} ) \times 100 \qquad ( 22 )$$

Accordingly, the present disclosure provides various advantages. For example, in an embodiment, predicted data traffic volume for each of a plurality of UE in the CAN 100 is combined with inter-UE traffic consideration to jointly optimize capacity maximization for aerial cells, latency minimization in inter-UE communication, and aerial fleet size minimization. In an embodiment, the disclosed techniques minimize the blocking ratio and simultaneously minimize

$$U x N {B}_{i}^{a v l} ( t ) ,$$

thereby improving resource utilization. Further, as the UEs associated with the same UxNB may locally communicate via a single hop, the backhaul communication is reduced, lowering both latency as well as network energy.

In this application, unless specifically stated otherwise, the use of the singular includes the plural, and the use of “or” means “and/or.” Furthermore, the use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

While at least one example embodiment has been presented in the foregoing detailed description, a vast number of variations exist.

What is claimed is:

1. A method for managing data traffic in an aerial communication network, the method comprising:
predicting the data traffic for each of a plurality of user equipment (UEs) for an aerial scheduling period (ASP), wherein the plurality of UEs are connected to a plurality of aerial base stations (UxNBs) in the aerial communication network;
creating a time-variant adjacency scheme for the plurality of UEs for the ASP, wherein the time-variant adjacency scheme indicates an inter-UE communication weight between each pair of UEs among the plurality of UEs;
forming a plurality of group of UEs based on the time-variant adjacency scheme for the ASP, wherein the inter-UE communication weight between each pair of UEs in the plurality of group of UEs exceeds a predefined threshold value; and
allocating each group of UEs among the plurality of group of UEs to an aerial base station (UxNB) among the plurality of UxNBs, based on at least one of the predicted data traffic, coverage information of each UE in a corresponding group of UEs, and a predefined capacity of the UxNB, wherein the coverage information of each UE matches with a coverage zone of the UxNB.

2. The method of claim 1, wherein the allocating each group of the UEs comprises allocating a number of UEs in the corresponding group of UEs to the UxNB, when the number of UEs is within the coverage zone of the UxNB.

3. The method of claim 1, further comprising dynamically adjusting the allocating each group of the UEs to the UxNB, based on at least one of mobility of the corresponding UE, the predicted data traffic of the corresponding UE, and network conditions associated with the aerial communication network.

4. The method of claim 1, further comprising transmitting a conditional handover (CHO) command comprising a list of UxNBs to at least one UE among the plurality of UEs, wherein one or more UxNBs in the list of UxNBs are selected based on the allocation of each group of the UEs to the UxNB.

5. The method of claim 1, further comprising:
updating the coverage zone of the UxNB at a starting time point of the ASP based on a predefined trajectory plan for the UxNB; and
updating the allocation of each group of the UEs to the UxNB based on the updated coverage zone.

6. The method of claim 1, wherein a total number of UxNBs used for allocation in the ASP is less than or equal to a total number of available UxNBs.

7. The method of claim 1, wherein the predicting the data traffic comprises predicting the data traffic based on at least one of historical data of the corresponding UE, real-time network conditions associated with the aerial communication network, and predicted communication requirements for the corresponding UE.

8. The method of claim 1, wherein the inter-UE communication weight indicates a strength of communication between the corresponding pair of UEs.

9. A system for managing data traffic in an aerial communication network, the system comprising at least one processor configured to:
predict data traffic for each of a plurality of user equipment (UEs) for an aerial scheduling period (ASP), wherein the plurality of UEs are connected to a plurality of aerial base stations (UxNBs) in the aerial communication network;
create a time-variant adjacency scheme for the plurality of UEs for the ASP, wherein the time-variant adjacency scheme indicates an inter-UE communication weight between each pair of UEs among the plurality of UEs;
form a plurality of group of UEs based on the time-variant adjacency scheme for the ASP, wherein the inter-UE communication weight between each pair of UEs in the plurality of group of UEs exceeds a predefined threshold value; and
allocate each group of UEs among the plurality of group of UEs to an aerial base station (UxNB) among the plurality of UxNBs, based on at least one of the predicted data traffic, a coverage information of each UE in a corresponding group of UEs, and a predefined capacity of the UxNB, wherein the coverage information of each UE matches with a coverage zone of the UxNB.

10. The system of claim 9, wherein, for allocating each group of the UEs, the at least one processor is further configured to allocate a number of UEs in the corresponding group of UEs to the UxNB, when the number of UEs are within the coverage zone of the UxNB.

11. The system of claim 9, wherein the at least one processor is further configured to dynamically adjust an allocation of each group of the UEs to the UxNB, based on at least one of mobility of the corresponding UE, the predicted data traffic of the corresponding UE, and network conditions associated with the aerial communication network.

12. The system of claim 9, wherein the at least one processor is further configured to transmit a conditional handover (CHO) command comprising a list of UxNBs to at least one UE among the plurality of UEs, wherein one or more UxNBs in the list of UxNBs are selected based on the allocation of each group of the UEs to the UxNB.

13. The system of claim 9, wherein the at least one processor is further configured to:
update the coverage zone of the UxNB at a starting time point of the ASP based on a predefined trajectory plan for the UxNB; and
update the allocation of each group of the UEs to the UxNB based on the updated coverage zone.

14. The system of claim 9, wherein a total number of UxNBs used for allocation in the ASP is less than or equal to a total number of available UxNBs.

15. The system of claim 9, wherein the at least one processor is configured to predict the data traffic, based on at least one of historical data of the corresponding UE, real-time network conditions associated with the aerial communication network, and predicted communication requirements for the corresponding UE.

16. The system of claim 9, wherein the inter-UE communication weight indicates a strength of communication between the corresponding pair of UEs.

17. A method for managing data traffic of a plurality of user equipment (UEs) in an aerial communication network, the method comprising:
predicting data traffics of the plurality UE during an aerial scheduling period (ASP), wherein the plurality of UEs are operatively connected to a plurality of aerial base stations (UxNBs) in the aerial communication network;
calculating a time-variant adjacency scheme about the plurality of UEs for the ASP, wherein the time-variant adjacency scheme is a matrix including inter-UE communication weights among the plurality of UEs;
forming a group of UEs based on the time-variant adjacency scheme for the ASP, wherein an inter-UE communication weight of the group of UEs exceeds a predefined threshold value; and
allocating the group of UEs to an aerial base station (UxNB) among the plurality of UxNBs, based on at least one of the predicted data traffic, coverage information of each UE in the group of UEs, and a predefined capacity of the UxNB, wherein the coverage information of each UE matches with a coverage zone of the UxNB.

18. The method of claim 17, wherein the allocating the group of UEs to the UxNB comprises allocating a number of UEs in the group of UEs to the UxNB, when the number of UEs is within the coverage zone of the UxNB.

19. The method of claim 17, further comprising dynamically adjusting the allocating the group of UEs to the UxNB, based on at least one of mobility of a UE of the group of UEs, the predicted data traffic of the UE of the group of UEs, and network conditions associated with the aerial communication network.

20. The method of claim 17, further comprising transmitting a conditional handover (CHO) command comprising a list of UxNBs to at least one UE among the plurality of UEs, wherein one or more UxNBs in the list of UxNBs are selected based on the allocating the group of UEs to the UxNB.
